(19) United States
(12) Patent Application Publication
(10) Pub. No.: US 2020/0184387 A1
(43) Pub. Date: Jun. 11, 2020

(54) PLATFORM USING SWAPPABLE POLICIES TO SIMULATE AND PERFORM WAREHOUSE PROCESSES

(71) Applicant: Target Brands, Inc., Minneapolis, MN (US)

(72) Inventors: Kaveh Khodjasteh Lakelayeh, Minneapolis, MN (US); Michael Rorro, Minneapolis, MN (US); Tikhon Jelvis, Minneapolis, MN (US); Bryce Cooks, Minneapolis, MN (US)

(73) Assignee: Target Brands, Inc., Minneapolis, MN (US)

(21) Appl. No.: 16/681,222

(22) Filed: Nov. 12, 2019

Related U.S. Application Data
(60) Provisional application No. 62/776,327, filed on Dec. 6, 2018.

(51) Int. Cl. G06Q 10/06; G06Q 10/08

(52) U.S. Cl. CPC G06Q 10/067; G06Q 10/0633; G06Q 10/08

(57) ABSTRACT

In some implementations, a method performed by data processing apparatuses includes receiving order data that defines one or more orders for items to be transported, selecting a first combination of policies for a plurality of sub-processes, each policy representing a strategy for performing a respective sub-process included in an overall process for transporting the items, performing a first simulation based on the first selected policy combination, selecting a second, different combination of policies for the plurality of sub-processes, performing a second simulation based on the second selected policy combination, comparing results of the first simulation and results of the second simulation, and based on the comparison, selecting one of the first combination of policies or the second combination of policies as an optimized policy combination.

### CROSS-REFERENCE TO RELATED APPLICATIONS

This application claims priority to U.S. Application Ser. No. 62/776,327, filed on Dec. 6, 2018. The disclosure of the prior application is considered part of the disclosure of this application, and is incorporated in its entirety into this application.

### TECHNICAL FIELD

This specification generally relates to a platform for simulating and optimizing warehouse operations, such as processes for distributing physical items from a warehouse to a store.

### BACKGROUND

Warehouse management systems (WMS) can perform a variety of operations to manage the physical distribution of goods in and out of warehouses. For example, a WMS can receive orders to be distributed from a warehouse and can translate those orders into specific warehouse operations, such as selecting particular pallets from locations in the warehouse and loading them onto trucks for distribution. WMS systems have traditionally been designed to focus on processing orders within the warehouse. For example, a WMS may simply identify operations that are needed to fulfill an order and send those out to be performed by the next available resource within the warehouse (e.g., send out instructions to forklift operator).

Simulation modeling platforms have been used to facilitate simulation modeling for various business and industrial processes. Within the simulation platforms, users may develop custom models for discrete elements (e.g., processes and agents), and may define interactions between the elements. By performing simulations, for example, experiments may be conducted to determine how randomness and parameter changes affect model behavior. Simulation results may be analyzed and changes may be made based on the analysis to improve the business and industrial processes.

### SUMMARY

This document generally describes computer systems, processes, program products, and devices for providing a platform to simulate and/or perform warehousing operations using swappable policies. The platform can be designed to efficiently test, generate, and use sets of swappable policies that will efficiently determine warehousing operations that optimize considerations for the entire supply chain (not simply optimizing warehousing considerations). For example, focusing solely on warehousing considerations, such as how to most efficiently and/or quickly process orders within the warehouse, may make operations performed by other parts of the supply chain less efficient, such as placing products distributed from a warehouse on store shelves. For instance, it may be more efficient from a warehousing perspective to pack pallets that are distributed to a store as full as possible. However, this may make the store operations less efficient when the pallet is packed with goods that have product placement locations scattered about different locations. While warehousing operations themselves can create complexity, adding in considerations for the other parts of the supply chain can create significant complexity that poses computational difficulties. For example, considering all of the possible options and variations for warehousing operations to account for considerations of the entire supply chain may be computationally inefficient and may not be practically solvable in real time, or on a recurring basis, as would be performed by a system (e.g., WMS) repeatedly processing orders.

The platforms disclosed throughout this document are designed to generate and facilitate the customization of multiple types of policies that can be mixed and matched to improve a supply chain as a whole. Swappable policies, for example, can include multiple layers, can be used to more efficiently arrive at a set of warehousing operations to fulfill warehouse orders, and can provide an optimized solution for the entire supply chain. Each of the layers of swappable policies can focus on one or more factors of the ultimate warehousing solution, such as timing, grouping of products, and others. For instance, performing simulations of distribution processes may be technically challenging due to the complexity and sheer volume of possible different options for various factors and sub-processes involved. The potential consideration of an overall process for distributing physical items from a warehouse to a store, for example, may include sub-processes for determining how to group product orders into units for shipment, for determining a path that a unit takes through a warehouse when being prepared for shipment, for determining how units are to be sorted into containers, for prioritizing units for shipment, for loading containers into carrier vehicles, and for scheduling when various tasks will be performed and when delivery vehicles will arrive and depart. Each of the sub-processes may be performed according to various different policies. In general, policies can be described using mathematical formulas for arriving at a decision given available data. A policy for placing multiple items in a container, for example, may be described by formulas that place the items in the container according to size (e.g., placing the largest items first). In some implementations, a policy may include a set of rules for performing a sub-process, may accept one or more parameters, and may generate output data, with different policies including different rules, possibly different input parameters, and possibly different output data. When performing a simulation of distributing physical items, for example, many different policy combinations may be attempted for the various sub-processes to determine an optimized overall process. The disclosed technology can provide techniques to facilitate swapping in and out policies when performing a simulation, and to facilitate chaining simulations of sub-processes together to generate results for an overall simulation.

In some implementations, a method performed by data processing apparatuses includes receiving order data that defines one or more orders for items to be transported from a first location to a second location; selecting a first combination of policies for a plurality of sub-processes, each policy representing a strategy for performing a respective sub-process included in an overall process for transporting the items from the first location to the second location; performing a first simulation based on the first selected policy combination; selecting a second, different combination of policies for the plurality of sub-processes; performing a second simulation based on the second selected policy combination; comparing results of the first simulation and results of the second simulation; and based on comparing results of the first simulation and results of the second simulation, selecting one of the first combination of policies or the second combination of policies as an optimized policy combination.

Other implementations of this aspect include corresponding computer systems, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. The first combination of policies and the second combination of policies can each include a scheduling policy for executing a scheduling sub-process, a unit of measure policy for executing a unit of measure sub-process, a process flow policy for executing a process flow sub-process, a sort policy for executing a sort sub-process, an order prioritization policy for executing an order prioritization sub-process, and an containerization policy for executing a containerization sub-process. The scheduling policy can include one or more rules for determining when other sub-processes are to occur. Performing the first simulation and the second simulation can each include passing data from the unit of measure sub-process to the process flow sub-process, passing data from the process flow sub-process to the sort sub-process, passing data from the sort sub-process to the order prioritization sub-process, and passing data from the order prioritization sub-process to the containerization sub-process. Comparing results of the first simulation and results of the second simulation can include comparing one or more first measured metric values resulting from the first simulation and one or more second measured metric values resulting from the second simulation. Selecting one of the first combination of policies or the second combination of policies as an optimized policy combination can include selecting a combination of policies that was used in a simulation that produced preferred measured metric values. First instructions can be generated for performing the first simulation, and second, different instructions can be generated for performing the second simulation. Runtime instructions based on the optimized policy combination can be generated, and the instructions can be provided for actual performance in a physical environment. Actual measured metric values based on actual performance of the runtime instructions in the physical environment can be received. The actual measured metric values can be compared with measured metric values resulting from a simulation that uses the optimized policy combination. A source of a discrepancy between the actual measured metric values and the measured metric values resulting from the simulation that uses the optimized policy combination can be identified. Different order data can be received that defines one or more different orders for items to be transported. An optimized policy combination can be selected, based at least in part on one or more factors associated with the order data being similar to one or more factors associated with the different order data. Runtime instructions based on the optimized policy combination can be generated, and the instructions can be provided for actual performance in a physical environment. The one or more factors can include one or more of the order data and the different order data being associated with a same first location or a same second location.

The systems, devices, program products, and processes described throughout this document can, in some instances, provide one or more of the following advantages. A simulation platform may use policies that, while being modeled on different strategies for performing real processes, are configured for execution in a virtual computer environment—thus, use of the simulation platform may be more efficient (e.g., may be executed in less time and at less cost) than modifying real operations and measuring real impact. Comparison of policies and/or policy combinations may lead to improved policies and/or different processes. Policies used for simulating sub-processes of an overall process may be readily swapped, facilitating an execution and comparison of a large number of policy combinations when determining an optimized policy combination. A flexible framework may be employed to facilitate chaining simulations of sub-processes together to generate results for an overall simulation. Using the flexible framework, solutions may be simultaneously determined for an optimal configuration (e.g., item containerization within a carrier vehicle) and for an optimal process to arrive at the optimal configuration (e.g., instructions for the item containerization). Policies used in a simulation may be separated from the framework that implements the policies, facilitating development and maintenance of the policies and the framework. A feedback loop may be used to determine whether simulations are accurate through comparisons of simulation results with measured data. Optimized sets of warehousing operations can be determined in an efficient manner that generate optimized solutions for the entire supply chain (and not just optimized for the warehouse itself).

Other features, aspects and potential advantages will be apparent from the accompanying description and figures.

### DESCRIPTION OF DRAWINGS

FIG. 1A is a conceptual diagram of an example system for performing process simulations using swappable policies.

FIG. 1B is a conceptual diagram of an example environment for performing simulations of distribution processes.

FIG. 1C shows an example of policy combination optimizations.

FIG. 2 shows an example process for selecting an optimized policy combination based on simulation results.

FIG. 3 shows an example process for generating instructions based on a selected optimized policy combination.

FIG. 4 is a conceptual diagram of an example framework for performing simulations of distribution processes using swappable policies.

FIG. 5 is a schematic diagram that shows an example of a computing system.

Like reference symbols in the various drawings indicate like elements

### DETAILED DESCRIPTION

This document describes technology that can perform process simulations using swappable policies. Simulating distribution processes may be generally challenging from a technical perspective due to the complexity of sub-processes involved, many of which may include randomness and uncertainty. For example, an overall process for distributing physical items from a warehouse to a store may include sub-processes for determining how to group product orders into units for shipment (e.g., individual items, cases), for determining a path that a unit takes through a warehouse when being prepared for shipment, for determining how units are to be sorted into containers (e.g., pallets, boxes), for prioritizing units for shipment, for loading containers into carrier vehicles (e.g., trucks), and for scheduling when various tasks will be performed and when delivery vehicles will arrive and depart. To solve this problem, a flexible policy framework can implement various swappable policies for each the sub-processes included in the overall process. A policy, for example, can include a set of rules for performing a sub-process, can accept one or more parameters, and can generate output data, with different policies including different rules, possibly different input parameters, and possibly different output data. Many different policy combinations may be readily evaluated when simulating the various sub-processes, and simulations of the sub-processes may be chained together within the policy framework to simulate and determine an optimal overall process.

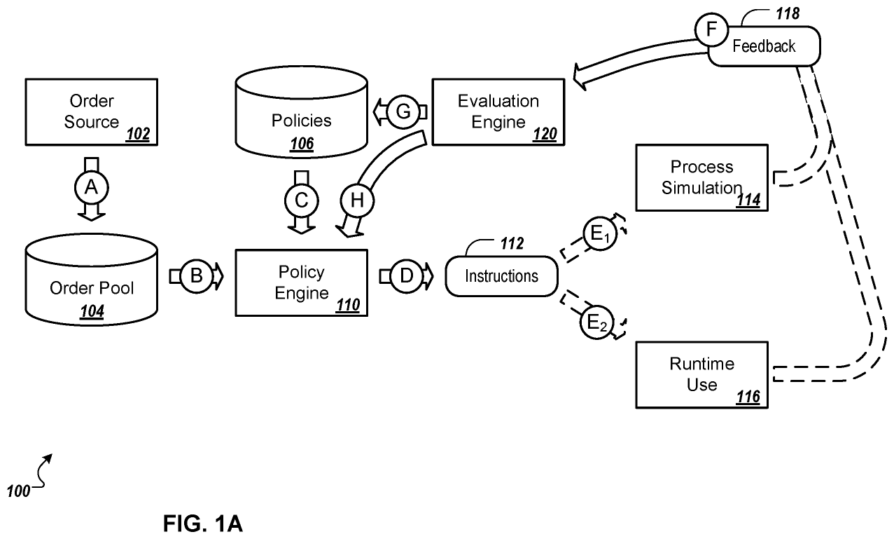

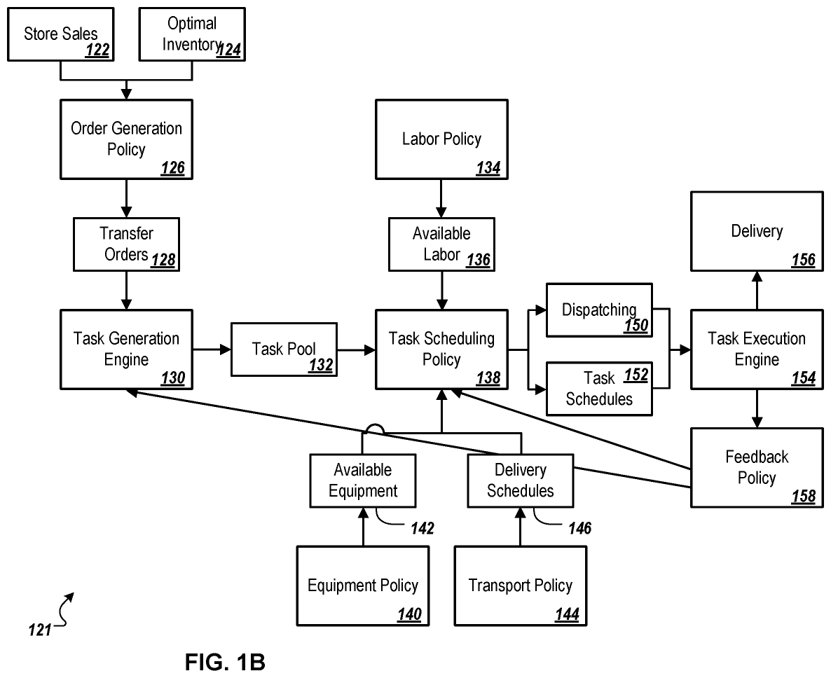

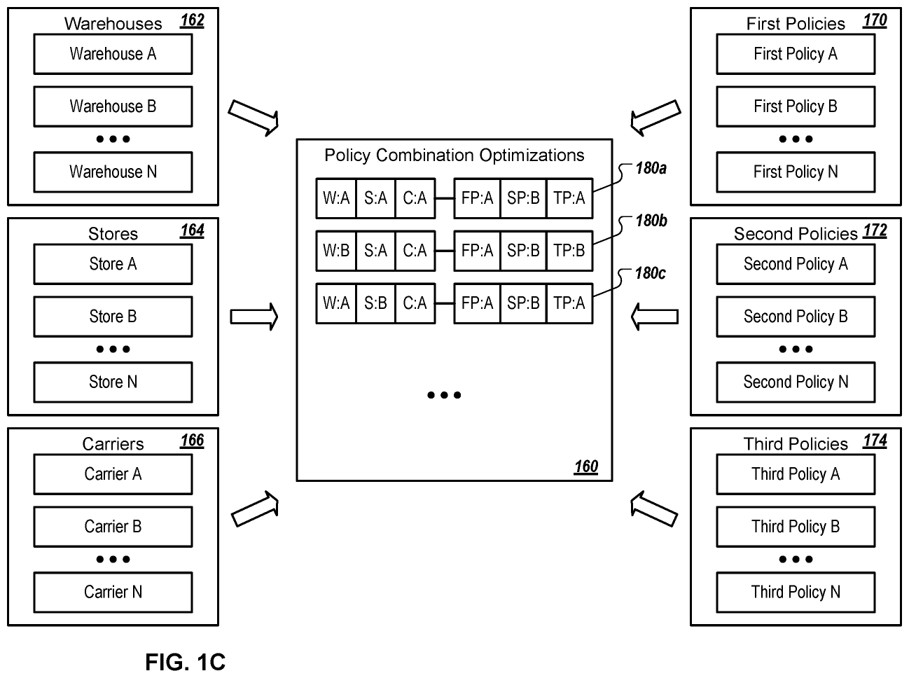

FIG. 1A is a conceptual diagram of an example system 100 for performing process simulations using swappable policies, as represented in example stages A-H. In the depicted example, the system 100 can be used for generating instructions for processing item delivery orders for distributing physical items from a warehouse to a store. The system 100 can include, for example, a WMS that is configured to use swappable policies to simulate and/or perform warehousing operations. The generated instructions can be used for process simulations and/or for runtime use, for example, and feedback can be used to refine the policies and/or policy framework.

In general, one or more simulations may be used to imitate various warehousing operations. The simulations, for example, can be executed by one or more computing devices which model the operations over time using a collection of state variables that represent a current state of various entities (e.g., workers, vehicles, equipment, containers, products, etc.) within a system (e.g., a warehouse, a store, etc.). The state variables, for example, can be modified by the simulations to model the evolution of the system over time.

At stage A, for example, order data is received from an order source 102. In some implementations, order data may include data that defines orders for one or more items (e.g., products) to be transported from a first location (e.g., a warehouse) to a second, different location (e.g., a store, a residence). For example, the order data can include a product identifier, a product quantity, an order timestamp, a requested delivery date/time, a requested delivery location, and other relevant information for one or more orders. In some implementations, order data may represent orders generated by an order simulation. For example, the order source 102 can be a separate computer simulation that generates order data that represents product orders (e.g., store orders, customer orders) that statistically resemble real orders, based on historical and/or projected product demand. In some implementations, order data may represent actual orders. For example, the order source 102 can be a computer system that provides order data for orders that have been placed by various entities (e.g., stores, customers). Regardless of the type of order source, order data received from the order source 102 can be added to an order pool 104. For example, the order pool 104 can include one or more types of computer data storage (e.g., databases, file systems, and/or cached data sources) configured to store received order data.

At stage B, for example, order data is received, analyzed, and processed by a policy engine 110. For example, the policy engine 110 can execute software that analyzes and/or processes the received order data, and can run on one or more computing devices including, but not limited to network servers, application servers, or web servers. In general, the policy engine 110 implements a policy framework that manages an overall process for generating instructions for performing a task (e.g., distributing physical items from a warehouse to various stores and/or customers), the overall process including various sub-processes (e.g., grouping orders into units, routing units through a warehouse, sorting units into containers, prioritizing units for shipment, loading containers into vehicles, task scheduling, etc.). Each of the sub-processes, for example, may be associated with various policies, each policy representing a different strategy for carrying out the sub-process. A policy, for example, can include a set of rules for performing its respective sub-process according to a strategy.

In some implementations, order data may be periodically received by a policy engine. For example, the policy engine 110 can receive order data from the order pool 104 based on a defined schedule (e.g., 7:00 AM, 1:00 PM, and 5:00 PM, or another suitable schedule). As another example, the policy engine 110 can receive order data from the order pool 104 based on a defined interval (e.g., once per minute, once per hour, once per four hours, once per day, or another suitable interval). As another example, the policy engine 110 can receive order data from the order pool incrementally, and/or at arbitrary times, and the policy engine can process the received order data in a responsive manner.

In some implementations, order data may be provided to a policy engine in response to a command provided by a system user. For example, a user of the system 100 can provide a command to the policy engine 110 to receive order data from the order pool 104 after it has been populated by results from an order simulation. As another example, a user of the system 100 can provide a command to the policy engine 110 to receive order data from the order pool 104 at any time when instructions are desired for processing the order data (e.g., simulated order data and/or actual order data).

At stage C, for example, a policy combination is selected by the policy engine 110. For example, the policy engine 110 can access a policies data store 106 that stores, for each of a plurality of sub-processes of an overall process, one or more different policies for performing the sub-process. The policies data store 106, for example, can include one or more types of computer data storage (e.g., databases, file systems, and/or cached data sources) configured to store data that represents the policies. For example, each policy can be implemented through computer instructions that execute rules of the respective policy. Different policies generally represent alternative strategies for performing a given sub-process, and thus can include alternative rules, can possibly receive alternative sets of input parameters, and can possibly generate different output data. When selecting the policy combination, for example, the policy engine 110 can select, for each sub-process of an overall process, a suitable policy for executing the sub-process.

In some implementations, selecting a policy combination can be based, at least in part, on possible permutations of available policies. For example, when selecting a policy combination for sub-processes of an overall process to be simulated, the policy engine 110 can define and/or refer to a set of possible policy combinations, such that each policy combination in the set of possible policy combinations is a different policy combination. The policy engine 110, for example, can generate simulation instructions for each different policy combination, and can track which policy combination has been simulated. Each policy combination simulation can be performed using the same order data from the order pool 104 and a different policy combination, for example, such that simulation results may be equitably compared.

In some implementations, selecting a policy combination can be based, at least in part, on one or more selection rules. The policy engine 110, for example, can reference selection rules that define which policy combinations may feasibly be attempted. For example, a particular policy for performing a first sub-process may or may not be compatible with a particular policy for performing a second sub-process. As another example, a particular policy for performing a first sub-process may or may not be appropriate for processing order data having particular data values (e.g., orders for particular items, orders for items that are to be delivered to particular locations, orders that are to be delivered in particular timeframes, etc.). By considering the feasibility of possible policy combinations based on selection rules, for example, a number of policy combinations may be reduced, thus conserving processing resources.

In some implementations, selecting a policy combination can be based, at least in part, on stored policy combination preference data. For example, after performing multiple process simulations, each process simulation using a different policy combination, a preferred policy combination (e.g., an optimized combination) can be determined for order data having one or more attributes (e.g., orders for items of a particular type, orders for items that are to be delivered to a particular location, orders for items that are to be delivered in a particular timeframe, and/or another suitable attribute) and/or for orders associated with a combination of factors (e.g., an warehouse for fulfilling the order, a carrier for transporting an order shipment, and/or another suitable factor). When actual order data having the one or more attributes and/or being associated with the one or more factors is received from the order pool 104, for example, the policy engine 110 can select the preferred policy combination based on the one or more attributes and/or factors when generating process instructions to be carried out.

At stage D, process instructions can be generated. For example, the policy engine 110 can generate instructions 112 to perform an overall process based on the selected policy combination, including sub-processes included in the overall process. In some implementations, generated instructions may be compatible with a process simulation and/or with runtime use. At stage E₁, for example, the generated instructions 112 can be provided to a process simulation 114. For example, the process simulation 114 of the overall process, including sub-processes included in the overall process, can be executed by one or more servers, including, but not limited to network servers, application servers, or web servers. At stage E₂, for example, the generated instructions 112 can be provided for runtime use 116. For example, runtime use 116 can include an actual performance of the generated instructions 112 in a physical environment, such as a warehouse for distributing physical items to various stores and/or customers.

At stage F, after performing the process simulation 114 or the runtime use 116 based on the generated instructions 112, feedback 118 can be received by an evaluation engine 120. In general, the feedback 118 can include data associated with various measured metrics, such as an amount of time to complete a process, an amount of resources (e.g., equipment, labor, fuel, and/or financial resources) to complete the process, or other appropriate metrics. For example, the process simulation 114 based on the generated instructions 112 can produce simulation results that include the various measured metrics, whereas the runtime use 116 can be associated with the various measured metrics through data collection tools that track metrics that result from carrying out the generated instructions 112. The evaluation engine 120, for example, can execute software that evaluates the received feedback 118, and can run on one or more computing devices including, but not limited to network servers, application servers, or web servers.

In some implementations, feedback resulting from a process simulation of a policy combination may be compared with feedback resulting from a process simulation of one or more different policy combinations. For example, the system 100 can generate different instructions 112 for various different policy combinations, perform process simulation 114 for each of the different instructions 112, and compare different feedback 118 resulting from each process simulation, using the evaluation engine 120. In some implementations, comparing results of different policy combinations may include determining an optimized policy combination. Determining an optimized policy combination, for example, may be based on one or more factors, including determining that various metrics included in simulation results for the policy combination have values that meet predetermined threshold values, and/or determining that the various metrics have values that are preferable to values for metrics included in simulation results for other policy combinations. An optimized policy combination, for example, can be specifically determined for processing a particular batch of order data from the order pool 104, and/or can be generally determined for a batch of orders having one or more attributes (e.g., particular product types, particular delivery locations, particular delivery timeframes, or other suitable attributes) and/or other factors. After determining an optimized policy combination, for example, the system 100 can store data representing the combination for future reference.

In some implementations, feedback resulting from runtime use of generated instructions may be compared with feedback resulting from a process simulation based on the same instructions. For example, the system 100 can initially generate the set of instructions 112 for a selected policy combination, perform the process simulation 114 based on the instructions 112, and determine that the selected policy combination is an optimized combination. After determining that the policy combination is optimized, for example, the instructions 112 can be provided for runtime use 116, and the feedback 118 resulting from the runtime use 116 can be compared with the feedback 118 resulting from the process simulation 114. If discrepancies are identified by the evaluation engine 120 (e.g., the various measured metrics have substantially dissimilar values), for example, a source of a discrepancy may be identified in the process simulation 114 and/or in data collection techniques associated with the runtime use 116, and either or both processes may be improved. For example, improvements may lead to improved characterization of warehouse data and/or optimization of a warehouse policy selection.

In general, feedback resulting from a process simulation of a policy combination and/or feedback resulting from a process simulation may be used to determine an optimized policy combination during a process simulation and/or during runtime use. For example, a policy combination that has resulted in suboptimal delivery of items by a warehouse may be improved by comparing observed data from the runtime use 116 with simulated data from the process simulation 114. Such a comparison, for example, may be used to identify problems related to modeling system components (e.g., some orders may be processed in a way that is not properly characterized in a simulation.) As another example, the comparison may be used to improve policy selection and/or to generate alternate policies.

At stage G, one or more policies can be modified and/or added, based on evaluation results. For example, based on an evaluation of the feedback 118 by the evaluation engine 120, one or more current policies stored by the policies data store 106 can be modified, and/or one or more new policies can be generated and added. For example, a system administrator can modify the rules of a particular policy, modify its parameters, and/or modify its output to improve the instructions 112 generated when the policy is included in a policy combination. As another example, a system administrator can add a new policy to the policies data store 106 that models a new strategy for performing a particular sub-process included in an overall process.

At stage H, a policy framework for chaining simulations of sub-processes can be modified, based on evaluation results. For example, based on an evaluation of the feedback 118 by the evaluation engine 120, the policy engine 110 can be modified such that an execution of sub-processes of an overall process is changed (e.g., the sub-processes are executed in a different order, the sub-processes are executed simultaneously, the sub-processes share different data, or another suitable change).

As shown in the present example, and as will be described in additional examples below, stages A-H can be iterative, such that results for multiple different simulations can be readily compared, as well as results of simulations and runtime use. Based on a results comparison, for example, continuous improvements can be made to the sub-process policies and/or the overall framework for generating instructions based on the policies.

FIG. 1B is a conceptual diagram of an example environment 121 for performing simulations of distribution processes. In general, the example environment 121 includes a possible framework for linking sub-processes of an overall process for distributing physical items from a warehouse to various stores and/or customers, for passing data between the sub-processes, and generating instructions for the overall process.

In the present example, store sales data 122 and optimal inventory data 124 can be received by a sub-process that implements a selected order generation policy 126. For example, the order generation policy 126 can reference the store sales data 122 and optimal inventory data 124 for a particular store, and can generate transfer orders 128 (e.g., simulated and/or actual orders) for replenishing items for the store. A task generation engine 130 can receive the transfer orders 128, and can generate a task pool 132 that includes tasks for fulfilling the transfer orders. The task generation engine 130, for example, can execute software that analyzes and/or processes the transfer order 128, and can run on one or more computing devices including, but not limited to network servers, application servers, or web servers. In general, fulfilling transfer orders may include performing various types of tasks, such as grouping orders into units, routing units through a warehouse, sorting units into containers, prioritizing units for shipment, loading containers into vehicles, and so forth. Similar to the policy engine 110 (shown in FIG. 1A), for example, the task generation engine 130 can add tasks to the task pool 132 based on executing a selected policy for each task type.

As shown in the present example, tasks in the task pool 132 can be scheduled using a task scheduling policy 138. The task scheduling policy 138, for example, can perform scheduling based on availability of various resources, according to a schedule. For example, a labor policy 134 can be used to provide data representing available labor 136 to the task scheduling policy 138. An equipment policy 140, for example, can be used to provide data representing available equipment 142 (e.g., forklifts, pallets, carrier vehicles, and/or other equipment) to the task scheduling policy 138. A transport policy 144, for example, can be used to provide data representing delivery schedules 146 to the task scheduling policy 138.

As shown in the present example, based on available labor 136, available equipment 142, and delivery schedules 146, the task scheduling policy 138 can generate dispatching instructions 150 and task schedules 152 for performing tasks in the task pool 132. The dispatching instructions 150 and task schedules 152 can be received by a task execution engine 154 (e.g., similar to the process simulation 114, shown in FIG. 1A), which can simulate and/or facilitate a delivery 156, and can in turn use a feedback policy 158 to provide feedback to the task generation engine 130 and/or the task scheduling policy 138.

FIG. 1C shows an example of policy combination optimizations. In general, optimized policy combinations may be determined for sub-processes included in an overall process, based on one or more attributes and/or other factors related to the overall process. When determining an optimized policy combination for sub-processes included in an overall process for fulfilling item delivery orders, for example, one or more attributes related to order data (e.g., particular product types, particular delivery locations, particular delivery timeframes, or other suitable attributes), and/or one or more factors related to a delivery environment (e.g., warehouses from which products are to be delivered, carriers that are to deliver the products, or other suitable attributes) may be considered.

In the present example, policy combination optimizations 160 can be determined and stored (e.g., by the policy engine 110 and policies data source 106, shown in FIG. 1A) for various combinations of warehouses 162, stores 164, and carriers 166. For each warehouse of the warehouses 162 (e.g., Warehouse A, Warehouse B, Warehouse N, etc.), for example, the policy engine 110 can receive data associated with the warehouse, such as layout data, product location data, resource data (e.g., labor, equipment, etc.), schedule data, and other suitable data. Similarly, for each store of the stores 164 (e.g., Store A, Store B, Store N, etc.), for example, the policy engine 110 can receive data associated with the store, such as layout data, product location data, resource data (e.g., labor, equipment, etc.), schedule data, and other suitable data. Similarly, for each carrier of the carriers 166 (e.g., Carrier A, Carrier B, Carrier N, etc.), for example, the policy engine 110 can receive data associated with the carrier, such as carrier capacity, resource data (e.g., labor, fuel consumption, etc.), schedule data, and other suitable data.

For each different combination of warehouse 162, store 164, and carrier 166, for example, a different combination of policies may be optimal for performing sub-processes included in an overall order fulfillment process, such as sub-processes for grouping orders into units, routing units through a warehouse, sorting units into containers, prioritizing units for shipment, loading containers into vehicles, and other suitable sub-processes. In the present example, various first policies 170 (e.g., First Policy A, First Policy B, First Policy N, etc.) can be considered for a first sub-process, various second policies 172 (e.g., Second Policy A, Second Policy B, Second Policy N, etc.) can be considered for a second sub-process, and various third policies 174 (e.g., Third Policy A, Third Policy B, Third Policy N, etc.) can be considered for a third sub-process. Each of the first policies 170, second policies 172, and third policies 174, for example, can be stored by the policies data store 106 (shown in FIG. 1A).

After performing various different policy simulations 114 (shown in FIG. 1A), based on various different policy combinations (e.g., including first policies 170, second policies 172, and third policies 174), and based on data associated with a combination of factors under consideration (e.g., a combination of warehouse, store, and carrier), a policy combination optimization can be determined for fulfilling orders associated with the combination of factors. In the present example, for Warehouse A, Store A, and Carrier A, an optimized policy combination 180a includes using First Policy A to perform a first sub-process, using Second Policy B to perform a second sub-process, and using Third Policy A to perform a third sub-process. For fulfilling orders associated with a different combination of factors, similar or different policy combinations may be optimal. For example, for Warehouse B, Store A, and Carrier A, a different optimized policy combination 180b includes First Policy A, Second Policy B, and Third Policy B, whereas for Warehouse A, Store B, and Carrier A, an optimized policy combination 180c also includes First Policy A, Second Policy B, and Third Policy A.

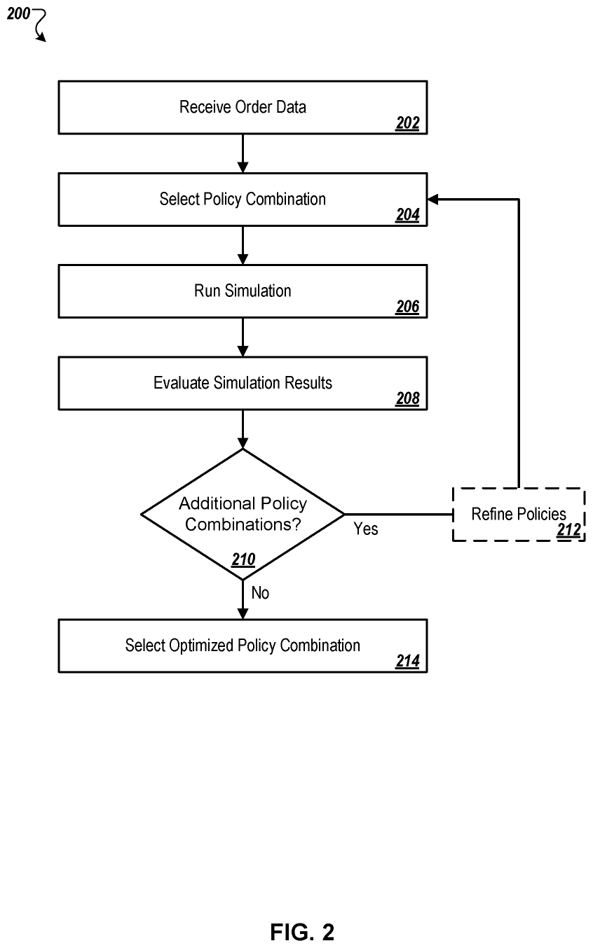

Referring now to FIG. 2, an example process 200 for selecting an optimized policy combination based on simulation results is shown. The process 200 can be performed by components of the system 100, for example, and will be described with reference to FIG. 1A. However, other systems (e.g., as shown in FIG. 1B) may be used to perform the same or a similar process, such as being implemented as part of a WMS and/or other warehouse management platform.

At box 202, order data is received. Referring again to FIG. 1A, for example, the policy engine 110 can receive order data from the order pool 104. The order data, for example, can include data that defines orders for products to be transported from a warehouse to a store, and may be based on results from an order generation simulation or may be based on actual orders. The order data, for example, may be periodically received by the policy engine 110 or may be provided to the policy engine in response to command provided by a system user.

At box 204, a policy combination is selected. For example, the policy engine 110 can access the policies data store 106 that stores, for each sub-process of an overall order fulfillment process, one or more different policies for performing the sub-process. Selecting the policy combination, for example, can be based on selecting a permutation of available polices that has not yet been analyzed and/or can be based on one or more selection rules.

At box 206, a simulation is performed using the selected policy combination. For example, the policy engine 110 can perform the process simulation 114 based on the policy combination selected by the policy engine 110. In some implementations, performing a process simulation may include processing generated instructions. For example, the instructions 112 generated by the policy engine 110 for the process simulation 114 can include instructions for performing tasks included in an overall order fulfillment process.

At box 208, simulation results are evaluated. For example, the evaluation engine 120 can receive feedback 118 resulting from the process simulation 114 and can evaluate the feedback. Evaluating simulation results, for example, can include evaluating various metrics included in the simulation results, and comparing the metric values with metric values that have resulted from simulations that have been performed using different policy combinations.

At box 210, a determination of whether additional policy combinations are available is performed. For example, the policy engine 110 can track policy combinations when they are evaluated, and can determine whether any suitable policy combinations that have not yet been evaluated still exist. In some implementations, all possible policy combinations may be evaluated. In some implementations, a subset of all possible policy combinations may be evaluated, such that an optimal policy combination is more quickly determined. For example, the policy engine 110 can reference selection rules that limit possible permutations of policies in view of one or more previously selected policies. As another example, the policy engine 110 can limit possible permutations of policies by only evaluating policy combinations for a subset of policy types. As another example, the policy engine 110 can limit possible permutations of policies by limiting a number of variable policy parameters.

At box 212, one or more policies are optionally refined. For example, if a policy combination is identified as not being optimal, one or more policies included in the combination may be modified to include different rules, to accept different parameters, and/or to produce different output values.

At box 204, if additional policy combinations are available, another policy combination is selected. For example, the policy engine 110 can select another combination of policies from the policies data store 106, and the process 200 can continue at boxes 206 and 208.

At box 214, if additional policy combinations are unavailable, an optimized policy combination is selected. For example, the policy engine 110 can select an optimized combination of policies from the policies data store 106, based on the evaluations of simulation results performed by the evaluation engine 120. An optimized policy combination, for example, can be a combination that is associated with simulation results including metric values that meet predetermined threshold values, and/or including metric values that are preferable to values for metrics included in simulation results for other policy combinations. After determining an optimized policy combination (e.g., a policy combination that has been optimized for one or more factors, including one or more factors related to order data and/or one or more factors related to a delivery environment), for example, data representing the optimized policy combination can be stored for future reference.

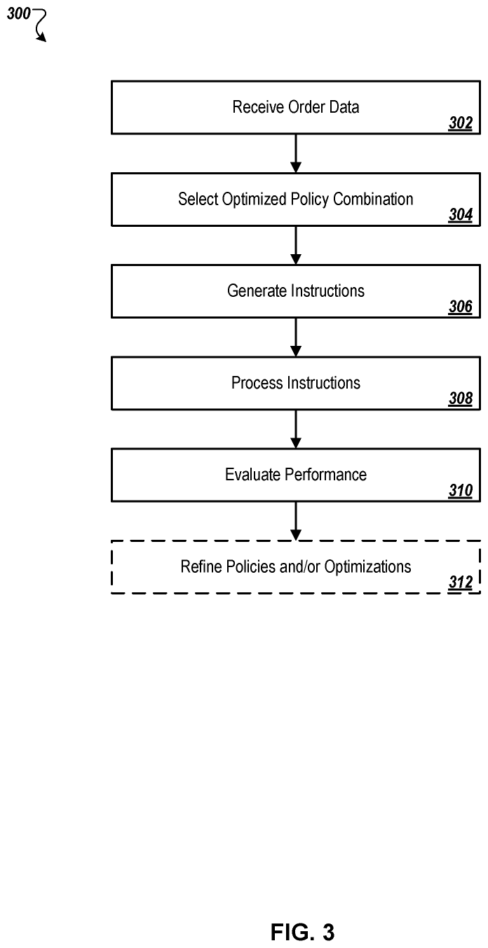

Referring now to FIG. 3, an example process 300 for generating instructions based on a selected optimized policy combination is shown. The process 300 can be performed by components of the system 100, for example, and will be described with reference to FIG. 1A. However, other systems (e.g., as shown in FIG. 1B) may be used to perform the same or a similar process, such as being implemented as part of a WMS and/or other warehouse management platform.

At box 302, order data is received. Referring again to FIG. 1A, for example, the policy engine 110 can receive order data from the order pool 104. The order data, for example, can include data that defines orders for products to be transported from a warehouse to a store, and may be based on actual orders that have been placed and/or on projected orders for items. The order data, for example, may be periodically received by the policy engine 110, may be provided to the policy engine as a result of executing a scheduling policy, or may be provided to the policy engine in response to a command provided by a system user.

At box 304, an optimized policy combination is selected. For example, the policy engine 110 can access the policies data store 106 that stores, for each sub-process of an overall order fulfillment process, one or more different policies for performing the sub-process. Selecting the optimized policy combination, for example, can be based on stored policy optimization information. For example, after performing the process 200 for selecting an optimized policy combination based on simulation results (shown in FIG. 2), data representing the optimized policy combination can be stored. The stored optimized policy combination used to generate the simulation results, for example, may also be used for fulfilling the orders on which the simulation is based. As another example, the stored optimized policy combination may be selected when subsequent orders are received that share one or more common attributes with the earlier orders (e.g., particular product types, particular delivery locations, particular delivery timeframes, and/or other suitable attributes), and/or that share one or more factors related to its delivery environment (e.g., warehouses from which products are to be delivered, carriers that are to deliver the products, and/or other suitable factors).

At box 306, instructions are generated based on the optimized policy combination. For example, the policy engine 110 can generate instructions 112 based on the stored and selected optimized policy combination.

At box 308, the generated instructions are processed. For example, the instructions 112 can be provided for runtime use 116, including an actual performance of the generated instructions 112 in a physical environment, such as a warehouse for distributing physical items to various stores and/or customers.

At box 310, performance of the instructions is evaluated. For example, the evaluation engine 120 can receive feedback resulting from the runtime use 116 and can evaluate the feedback. Evaluating runtime results, for example, can include evaluating various measured metrics included in the runtime results, the metrics having been gathered through data collection tools that track metrics that result from carrying out the generated instructions 112.

At box 312, policies and/or optimizations are optionally refined. For example, if a selected policy combination does not produce runtime results that include metric values that meet a predetermined threshold value, one or more policies included in the optimized policy combination may be replaced or modified.

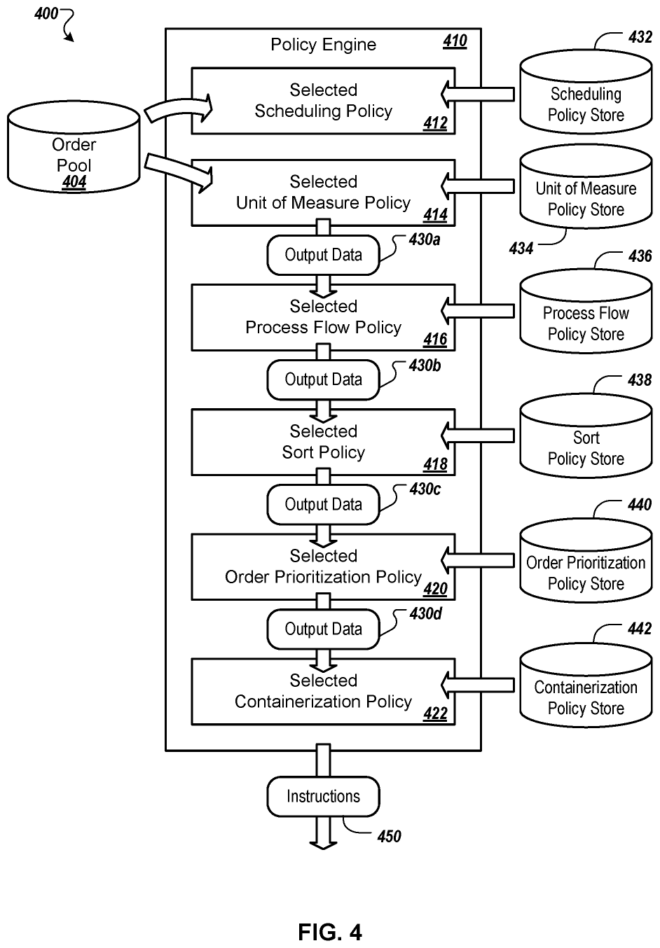

FIG. 4 is a conceptual diagram of an example framework 400 for performing simulations of distribution processes using swappable policies. The example framework 400 includes a policy engine 410 (e.g., similar to the policy engine 110, shown in FIG. 1A) that can receive, analyze, and process order data from an order pool 404 (e.g., similar to the order pool 104, also shown in FIG. 1A). The policy engine 410 shown in the present example can generate instructions 450 for processing item delivery orders, the instructions being usable for performing process simulations and/or for performing a physical process.

The policy engine 410, for example, includes a framework in which various sub-processes included in an overall order fulfillment process are chained together, each of the sub-processes being performed according to a swappable policy that may be selected from a respective data store. In the present example, the policy engine 410 can select a scheduling policy 412 from a scheduling policy data store 432, a unit of measure policy 414 from a unit of measure policy data store 434, a process flow policy 416 from a process flow policy data store 436, a sort policy 418 from a sort policy data store 438, an order prioritization policy 420 from an order prioritization policy data store 440, and a containerization policy 422 from a containerization policy data store 442.

The selected scheduling policy 412, for example, can be used to determine when order data from the order pool 404 is to be processed. In some implementations, determining when to process order data may be based at least in part on a defined schedule or interval. In some implementations, determining when to process order data may be based at least in part on determining when attributes of the order data are associated with particular values. For example, the selected scheduling policy 412 can determine that order data from the order pool 404 is to be processed when a number of orders represented in the order pool meets a threshold value. As another example, the selected scheduling policy 412 can determine that order data from the order pool 404 is to be processed when a type of product is represented in the order pool.

The selected unit of measure policy 414, for example, can be used to determine how to group orders into units for shipment. For example, orders can be grouped as individual items, store ship packs (e.g., a small collection of items placed in a box), or vendor case packs (e.g., a large collection of units packaged by a vendor). Possible unit of measure policies, for example, may include a constant policy and a greedy policy. For example, the constant policy can accept as parameters a unit of measure name parameter (e.g., individual item, store ship pack, or vendor case pack) and a round-down parameter (e.g., true or false). The constant policy, for example, returns only a type of unit of measure that corresponds to the unit of measure name parameter, and will either round up or down based on the value of the round-down parameter. The greedy policy, for example, can accept as parameters one or more eligible units of measure (e.g., individual item, store ship pack, and/or vendor case pack) and a round-down parameter (e.g., true or false). The greedy policy, for example, groups a set of orders by the largest unit of measure, then the middle unit of measure, then the smallest unit of measure, and will either round up or down if individual items are not selected based on the round-down parameter. Output data 430a generated by the selected unit of measure policy 414, for example, can include orders that have been grouped into respective units.

The selected process flow policy 416, for example, can be used to determine a path that a unit takes through a warehouse when being prepared for shipment. In some implementations, rules included in a process flow policy for determining a path for a unit may be based at least in part on various unit characteristics, such as size, weight, handling specifications, refrigeration specifications, and other suitable characteristics. In some implementations, rules included in a process flow policy for determining a path for a unit may be based at least in part on a capacity for the path. The determined path for a unit may be relevant to subsequent sub-processes, for example, because units that travel along different paths generally may not be placed in a same container. Output data 430b generated by the selected process flow policy 416, for example, can include units that have been assigned to particular paths.

The selected sort policy 418, for example, can be used to determine how units will be sorted into containers. In some implementations, rules included in a sort policy for a unit may be based at least in part on a location within a store (e.g., a department, an aisle, a section) at which the unit will be stocked. For example, the sort policy can determine that units that are to be stocked at a same location are to be sorted into a same container. In some implementations, rules included in a sort policy for a unit may be based at least in part on optimizing space within a container. Output data 430c generated by the selected sort policy 418, for example, can include units that have been assigned to particular paths and have been sorted into particular containers.

The selected order prioritization policy 420, for example, can be used to determine how units are to be prioritized for shipment. In general, order prioritization may be a factor when available space on a carrier vehicle (e.g., a truck) is limited, with units having a higher prioritization being loaded onto the vehicle rather than units having a lower prioritization. In some implementations, rules included in an order prioritization policy may be based at least in part on when an order for a unit was placed. For example, the order prioritization policy can determine that units are to be prioritized according to corresponding order placement timestamps. In some implementations, rules included in an order prioritization policy may be based at least in part on a value of potential sales of a unit. For example, the order prioritization policy can determine that units that are associated with higher potential sales are to be prioritized over units that are associated with lower potential sales. Output data 430d generated by the selected order prioritization policy 420, for example, can include units that have been assigned to particular paths, have been sorted into particular containers, and have been prioritized.

The selected containerization policy 422, for example, can be used to generate specific instructions 450 for moving units through a warehouse, packing the units into containers, and loading the units on to a carrier vehicle, until a vehicle capacity is reached, based on the output data 430d that has been sequentially added to by policies for implementing the previous sub-processes.

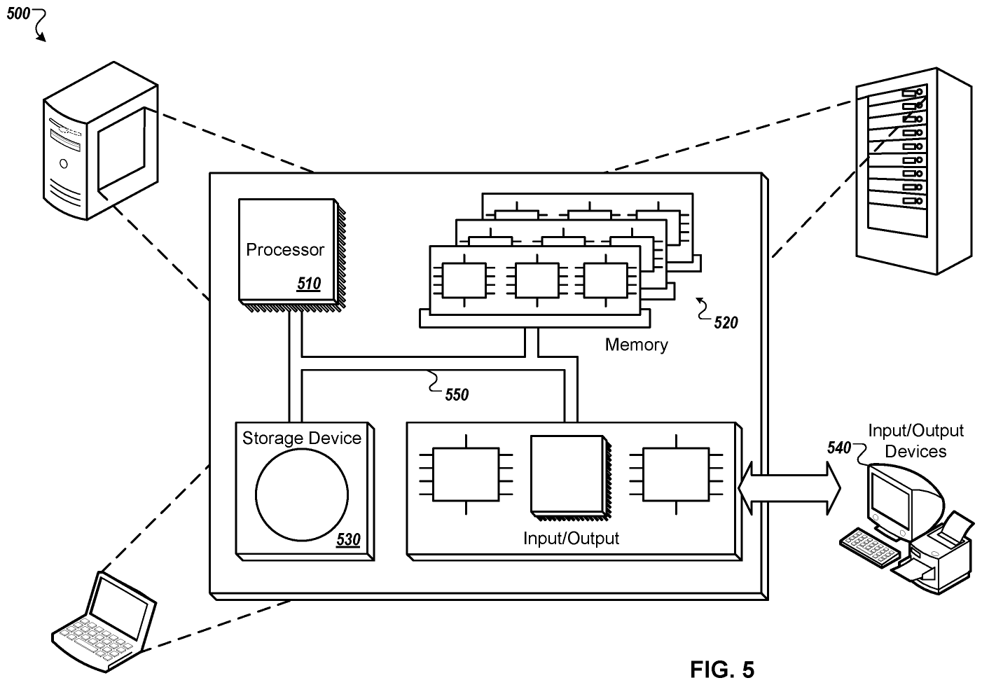

FIG. 5 is a schematic diagram that shows an example of a computing system 500. The computing system 500 can be used for some or all of the operations described previously, according to some implementations. The computing system 500 includes a processor 510, a memory 520, a storage device 530, and an input/output device 540. Each of the processor 510, the memory 520, the storage device 530, and the input/output device 540 are interconnected using a system bus 550. The processor 510 is capable of processing instructions for execution within the computing system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the computing system 500. In some implementations, the memory 520 is a computer-readable medium. In some implementations, the memory 520 is a volatile memory unit. In some implementations, the memory 520 is a non-volatile memory unit.

The storage device 530 is capable of providing mass storage for the computing system 500. In some implementations, the storage device 530 is a computer-readable medium. In various different implementations, the storage device 530 may be a floppy disk device, a hard disk device, an optical disk device, or a tape device.

The input/output device 540 provides input/output operations for the computing system 500. In some implementations, the input/output device 540 includes a keyboard and/or pointing device. In some implementations, the input/output device 540 includes a display unit for displaying graphical user interfaces.

Some features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM (erasable programmable read-only memory), EEPROM (electrically erasable programmable read-only memory), and flash memory devices; magnetic disks such as internal hard disks and removable disks; magneto-optical disks; and CD-ROM (compact disc read-only memory) and DVD-ROM (digital versatile disc read-only memory) disks. The processor and the memory can be supplemented by, or incorporated in, ASICs (application-specific integrated circuits).

To provide for interaction with a user, some features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

Some features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN (local area network), a WAN (wide area network), and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

What is claimed is:

1. A computer system comprising:
a data processing apparatuses including one or more processors, memory, and storage devices storing instructions that, when executed, cause the one or more processors to perform operations comprising:
receiving order data that defines one or more orders for items to be transported from a first location to a second location;
selecting a first combination of policies for a plurality of sub-processes, each policy representing a strategy for performing a respective sub-process included in an overall process for transporting the items from the first location to the second location;
performing a first simulation based on the first selected policy combination;
selecting a second, different combination of policies for the plurality of sub-processes;
performing a second simulation based on the second selected policy combination;
comparing results of the first simulation and results of the second simulation; and
based on comparing results of the first simulation and results of the second simulation, selecting one of the first combination of policies or the second combination of policies as an optimized policy combination.

2. The computer system of claim 1, wherein the first combination of policies and the second combination of policies each includes a scheduling policy for executing a scheduling sub-process, a unit of measure policy for executing a unit of measure sub-process, a process flow policy for executing a process flow sub-process, a sort policy for executing a sort sub-process, an order prioritization policy for executing an order prioritization sub-process, and a containerization policy for executing a containerization sub-process.

3. The computer system of claim 2, wherein the scheduling policy includes one or more rules for determining when other sub-processes are to occur.

4. The computer system of claim 2, wherein performing the first simulation and the second simulation each includes passing data from the unit of measure sub-process to the process flow sub-process, passing data from the process flow sub-process to the sort sub-process, passing data from the sort sub-process to the order prioritization sub-process, and passing data from the order prioritization sub-process to the containerization sub-process.

5. The computer system of claim 1, wherein comparing results of the first simulation and results of the second simulation includes comparing one or more first measured metric values resulting from the first simulation and one or more second measured metric values resulting from the second simulation, and wherein selecting one of the first combination of policies or the second combination of policies as an optimized policy combination includes selecting a combination of policies that was used in a simulation that produced preferred measured metric values.

6. The computer system of claim 1, the operations further comprising generating first instructions for performing the first simulation, and generating second, different instructions for performing the second simulation.

7. The computer system of claim 1, the operations further comprising:
generating runtime instructions based on the optimized policy combination; and
providing the instructions for actual performance in a physical environment.

8. The computer system of claim 7, the operations further comprising:
receiving actual measured metric values based on actual performance of the runtime instructions in the physical environment;
comparing the actual measured metric values with measured metric values resulting from a simulation that uses the optimized policy combination; and
identifying a source of a discrepancy between the actual measured metric values and the measured metric values resulting from the simulation that uses the optimized policy combination.

9. The computer system of claim 1, the operations further comprising:
receiving different order data that defines one or more different orders for items to be transported;
selecting the optimized policy combination, based at least in part on one or more factors associated with the order data being similar to one or more factors associated with the different order data;
generating runtime instructions based on the optimized policy combination; and
providing the instructions for actual performance in a physical environment.

10. The computer system of claim 9, wherein the one or more factors include one or more of the order data and the different order data being associated with a same first location or a same second location.

11. A computer-implemented method comprising:
receiving order data that defines one or more orders for items to be transported from a first location to a second location;
selecting a first combination of policies for a plurality of sub-processes, each policy representing a strategy for performing a respective sub-process included in an overall process for transporting the items from the first location to the second location;
performing a first simulation based on the first selected policy combination;
selecting a second, different combination of policies for the plurality of sub-processes;
performing a second simulation based on the second selected policy combination;
comparing results of the first simulation and results of the second simulation; and
based on comparing results of the first simulation and results of the second simulation, selecting one of the first combination of policies or the second combination of policies as an optimized policy combination.

12. The computer-implemented method of claim 11, wherein the first combination of policies and the second combination of policies each includes a scheduling policy for executing a scheduling sub-process, a unit of measure policy for executing a unit of measure sub-process, a process flow policy for executing a process flow sub-process, a sort policy for executing a sort sub-process, an order prioritization policy for executing an order prioritization sub-process, and a containerization policy for executing a containerization sub-process.

13. The computer-implemented method of claim 11, wherein comparing results of the first simulation and results of the second simulation includes comparing one or more first measured metric values resulting from the first simulation and one or more second measured metric values resulting from the second simulation, and wherein selecting one of the first combination of policies or the second combination of policies as an optimized policy combination includes selecting a combination of policies that was used in a simulation that produced preferred measured metric values.

14. The computer-implemented method of claim 11, further comprising generating first instructions for performing the first simulation, and generating second, different instructions for performing the second simulation.

15. The computer-implemented method of claim 11, further comprising:
generating runtime instructions based on the optimized policy combination; and
providing the instructions for actual performance in a physical environment.

16. The computer-implemented method of claim 11, further comprising:
receiving different order data that defines one or more different orders for items to be transported;
selecting the optimized policy combination, based at least in part on one or more factors associated with the order data being similar to one or more factors associated with the different order data;
generating runtime instructions based on the optimized policy combination; and
providing the instructions for actual performance in a physical environment.

17. A non-transitory computer-readable storage medium coupled to one or more processors and having instructions stored thereon which, when executed by the one or more processors, cause the one or more processors to perform operations comprising:
receiving order data that defines one or more orders for items to be transported from a first location to a second location;
selecting a first combination of policies for a plurality of sub-processes, each policy representing a strategy for performing a respective sub-process included in an overall process for transporting the items from the first location to the second location;
performing a first simulation based on the first selected policy combination;
selecting a second, different combination of policies for the plurality of sub-processes;
performing a second simulation based on the second selected policy combination;
comparing results of the first simulation and results of the second simulation; and
based on comparing results of the first simulation and results of the second simulation, selecting one of the first combination of policies or the second combination of policies as an optimized policy combination.

18. The non-transitory computer-readable storage medium of claim 17, wherein the first combination of policies and the second combination of policies each includes a scheduling policy for executing a scheduling sub-process, a unit of measure policy for executing a unit of measure sub-process, a process flow policy for executing a process flow sub-process, a sort policy for executing a sort sub-process, an order prioritization policy for executing an order prioritization sub-process, and an containerization policy for executing a containerization sub-process.

19. The non-transitory computer-readable storage medium of claim 17, wherein comparing results of the first simulation and results of the second simulation includes comparing one or more first measured metric values resulting from the first simulation and one or more second measured metric values resulting from the second simulation, and wherein selecting one of the first combination of policies or the second combination of policies as an optimized policy combination includes selecting a combination of policies that was used in a simulation that produced preferred measured metric values.

20. The non-transitory computer-readable storage medium of claim 17, the operations further comprising:
receiving different order data that defines one or more different orders for items to be transported;
selecting the optimized policy combination, based at least in part on one or more factors associated with the order data being similar to one or more factors associated with the different order data;
generating runtime instructions based on the optimized policy combination; and
providing the instructions for actual performance in a physical environment.
